(19) United States
(12) Patent Application Publication
(10) Pub. No.: US 2018/0281256 A1
(43) Pub. Date: Oct. 4, 2018

(54) STATE DETERMINATION APPARATUS

(71) Applicant: FANUC CORPORATION, Yamanashi (JP)

(72) Inventors: Hiroyasu ASAOKA, Yamanashi (JP); Atsushi HORIUCHI, Yamanashi (JP); Kenjirou SHIMIZU, Yamanashi (JP)

(21) Appl. No.: 15/933,245

(22) Filed: Mar. 22, 2018

(30) Foreign Application Priority Data
Mar. 29, 2017 (JP) 2017-064774

(51) Int. Cl. B29C 45/76; G06N 99/00; G05B 19/048

(52) U.S. Cl. CPC B29C 45/768; G06N 99/005; G05B 19/048; B29C 2945/76163; B29C 2945/76173; G05B 2219/2624; B29C 2945/76006; B29C 2945/76224; B29C 2945/7604; B29C 2945/76949; B29C 2945/76083

(57) ABSTRACT

A state determination apparatus for determining a state related to an abnormality of an injection molding machine based on an operation state of the injection molding machine includes a machine learning apparatus for learning the state related to the abnormality of the injection molding machine. The machine learning apparatus observes, as a state variable that represents a current state of an environment, injection data that indicates the operation state of the injection molding machine, acquires label data that indicates the state related to the abnormality of the injection molding machine, and performs learning by associating the observed state variable with the acquired label data.

### BACKGROUND OF THE INVENTION

### 1. Field of the Invention

The present invention relates to a state determination apparatus that determines a state related to an abnormality of an injection molding machine based on an operation state of the injection molding machine, and facilitates maintenance of the injection molding machine.

### 2. Description of the Related Art

Maintenance of an injection molding machine is performed periodically or when an abnormality occurs. As one of methods for determining the state of the injection molding machine in the maintenance of the injection molding machine, there is a method in which, regarding a mold opening/closing operation or a molded article ejecting operation in an injection molding cycle for manufacturing a molded article by using the injection molding machine, a load state of a motor for driving a movable portion is recorded in a memory or the like as a reference load at specific sampling intervals in association with time or the position of the movable portion, an actual motor load is successively compared with the recorded reference load in association with the time or the position of the movable portion, and it is determined whether the mold opening/closing operation or the ejecting operation is normal or abnormal based on whether or not a deviation between the actual motor load and the reference load exceeds a preset threshold value. Thus, when the injection molding machine is maintained, the state of an injection operation by the injection molding machine is determined by using a physical quantity indicative of an operation state of the injection molding machine which has been recorded during the operation of the injection molding machine.

As a conventional art for determining the state of the injection molding machine, for example, Japanese Patent Application Publication No. 2001-30326 or Japanese Patent Application Publication No. 2001-38775 discloses a technique that sets, as the reference load, a load in at least one normal mold opening/closing operation or ejecting operation performed previously, or a load obtained by calculating the movement average of a plurality of such operations performed previously.

Data acquired from the injection molding machine is recorded as two types of data pieces that include sampling data (discrete time-series data) that is acquired at specific sampling intervals for each molding cycle, and data that is acquired once for each molding cycle.

For example, each of FIGS. 9A to 9C is an example in which the torque of a motor for driving a plasticizing screw in an injection step of the injection molding machine is recorded. FIG. 9A shows an example of a time-torque curve of the motor in a given operation setting (assumed to be a condition A), FIG. 9B shows an example of the time-torque curve of the motor when the operation setting is changed in the same component (assumed to be a condition B), and FIG. 9C shows an example of the time-torque curve of the motor when the component is worn under the condition A. Data shown in each of FIGS. 9A to 9C is recorded as sampling data which has been acquired at specific sampling intervals for each molding cycle.

In addition, each set value of the operation setting and values indicative of characteristics of resin are recorded as data that is acquired once for each molding cycle.

Herein, as shown in FIGS. 9A and 9B, in the sampling data that is acquired at specific sampling intervals for each molding cycle, the shapes of the curves often resemble each other in the case where the operation condition of the injection step in the molding cycle differs (FIG. 9A and FIG. 9B). On the other hand, the time of the injection step differs depending on the operation setting, and hence the number of pieces of data, which is to be obtained in a time direction when the data is acquired at the same sampling intervals, differs. Consequently, what is indicated by the i-th value from the acquisition start in the sampling data differs among the molding cycles having different operation conditions, and hence a problem peculiar to the injection molding machine arises in that, in the case where the sampling data acquired in each molding cycle is examined in order to determine the state of the injection molding machine, when the sampling data is used without alteration, it is not possible to correctly determine the state of the injection molding machine. Such a problem becomes conspicuous, e.g., in the comparison of the sampling data between the molding cycles. For example, when the component is worn, as shown in FIGS. 9A and 9C, the shape of the curve changes even under the same operation condition. When FIG. 9A is compared with FIG. 9C (the operation conditions both being the operation condition A), it is possible to easily determine the change of the shape of the curve, but it is not possible to easily determine the change of the shape of the curve when FIG. 9B is compared with FIG. 9C (the operation condition being different between the condition B and the condition A).

In addition, the injection molding machine produces many types of articles in many cases, and hence a problem peculiar to the injection molding machine arises in that the condition significantly differs depending on a target article to be produced in one injection molding machine, and it is difficult to handle all pieces of the sampling data acquired under different conditions similarly.

### SUMMARY OF THE INVENTION

To cope with this, an object of the present invention is to provide a state determination apparatus capable of determining the state of the injection molding machine based on data acquired irrespective of the operation condition and the target article to be produced of the injection molding machine.

A state determination apparatus of the present invention is provided with a preprocessing section for performing preprocessing on information related to a molding operation of an injection molding machine acquired from the injection molding machine, adjusts, among pieces of information indicative of an operation state of the injection molding machine, data in which the number of data pieces or a scale is changed due to an operation condition using the preprocessing section, uses the adjusted data as an input for machine learning or data analysis, and thereby solves the above problems.

The state determination apparatus according to the present invention determines a state related to an abnormality of the injection molding machine based on the operation state of the injection molding machine.

A first aspect of the state detection apparatus according to the present invention includes a preprocessing section for executing preprocessing on at least one piece of time-series data included in data related to the operation state of the injection molding machine, and a machine learning apparatus for learning the state related to the abnormality of the injection molding machine correlated with the operation state of the injection molding machine. In addition, the machine learning apparatus includes a state observation section for observing, as a state variable that represents a current state of an environment, injection data that indicates the operation state of the injection molding machine and includes the piece of time-series data that has been subjected to the preprocessing by the preprocessing section, a label data acquisition section for acquiring label data that indicates the state related to the abnormality of the injection molding machine, and a learning section for performing learning by associating the state variable with the label data.

The state determination apparatus can further include an internal parameter setting section in which a fixed internal parameter related to the operation state of the injection molding machine is set, and the state observation section maybe configured to observe, as the state variable that represents the current state of the environment, each of the internal parameter and the injection data that indicates the operation state of the injection molding machine and includes the piece of time-series data that has been subjected to the preprocessing by the preprocessing section.

A plurality of internal parameters may be set in the internal parameter setting section, and one of the plurality of internal parameters may be selectable as the internal parameter observed as the state variable.

The learning section can include an error calculation section for calculating an error between a correlation model for determining the state related to the abnormality of the injection molding machine from the state variable and a correlation feature that is recognized from supervised data prepared in advance, and a model update section for updating the correlation model so as to reduce the error.

The learning section may be configured to compute the state variable and the label data with a multi-layer structure.

The state determination apparatus can further include a determination output section for outputting the state related to the abnormality of the injection molding machine determined based on the state variable and a result of the learning by the learning section.

The determination output section may be configured to output a warning in a case where the state related to the abnormality of the injection molding machine determined by the learning section exceeds a preset threshold value.

The preprocessing may be processing in which interpolation, extraction, or a combination of the interpolation and the extraction is performed on at least one piece of time-series data included in the data related to the operation state of the injection molding machine, and the number of input pieces of the time-series data is adjusted.

The data related to the operation state of the injection molding machine may be a value obtained by using at least one of a load of a drive portion or a movable portion of the injection molding machine, a speed of the drive portion or the movable portion, a position of the drive portion or the movable portion, an instruction value to the drive portion, a pressure, a mold clamping force, a temperature, a physical quantity of each molding cycle, a molding condition, a molding material, a molded article, a shape of a component of the injection molding machine, a distortion of the component of the injection molding machine, operating noise, and an image.

The injection molding machine can be caused to perform a predetermined specific operation for performing the determination of the state related to the abnormality of the injection molding machine by the learning section. In addition, the predetermined specific operation for performing the determination may be performed automatically or at the request of a worker. Further, a date and time when the predetermined specific operation for performing the determination has been performed may be stored, and information may be output in a case where a specific time period elapses from the stored date and time.

The state determination apparatus may be configured as part of a controller of the injection molding machine.

The state determination apparatus may be configured as part of a molding machine management apparatus for managing a plurality of injection molding machines via a network.

A second aspect of the state determination apparatus according to the present invention includes a preprocessing section for executing preprocessing on at least one piece of time-series data included in data related to the operation state of the injection molding machine, and a machine learning apparatus having a learning section that has learned the state related to the abnormality of the injection molding machine correlated with the operation state of the injection molding machine. In addition, the machine learning apparatus includes a state observation section for observing, as a state variable that represents a current state of an environment, injection data that indicates the operation state of the injection molding machine and includes the piece of time-series data that has been subjected to the preprocessing by the preprocessing section, and a determination output section for outputting the state related to the abnormality of the injection molding machine determined based on the state variable and a result of the learning by the learning section.

According to the present invention, it becomes possible to determine the state of the injection molding machine based on the data acquired irrespective of the operation condition and the target article to be produced of the injection molding machine.

### BRIEF DESCRIPTION OF THE DRAWINGS

FIG. 1 is a schematic functional block diagram of a state determination apparatus according to a first embodiment;

FIG. 2 is a schematic functional block diagram showing an aspect of the state determination apparatus;

FIG. 3A is a view for explaining a neuron constituting a neural network;

FIG. 3B is a view for explaining the neural network;

FIG. 4 is a schematic functional block diagram of a state determination apparatus according to a second embodiment;

FIG. 5 is a schematic functional block diagram showing another aspect of the state determination apparatus;

FIG. 6 is a schematic functional block diagram showing an aspect of an injection molding system;

FIG. 7 is a schematic functional block diagram showing another aspect of the injection molding system;

FIG. 8 is a schematic functional block diagram showing an aspect of the injection molding system that includes a molding machine management apparatus;

FIG. 9A is a view illustrating an example of a torque curve of a motor for driving a plasticizing screw in an injection step of an injection molding machine that operates under an operation condition A;

FIG. 9B is a view illustrating an example of the torque curve of the motor for driving the plasticizing screw in the injection step of the injection molding machine that operates under an operation condition B; and

FIG. 9C is a view illustrating an example of the torque curve of the motor for driving the plasticizing screw in the injection step of the injection molding machine in which a component expected to operate under the operation condition A has been worn away.

### DETAILED DESCRIPTION OF THE PREFERRED EMBODIMENTS

Examples of the configuration of a state determination apparatus for implementing the present invention are described below. Note that the configuration of the state determination apparatus of the present invention is not limited to the examples described below, and any configuration that can implement the object of the present invention may be adopted.

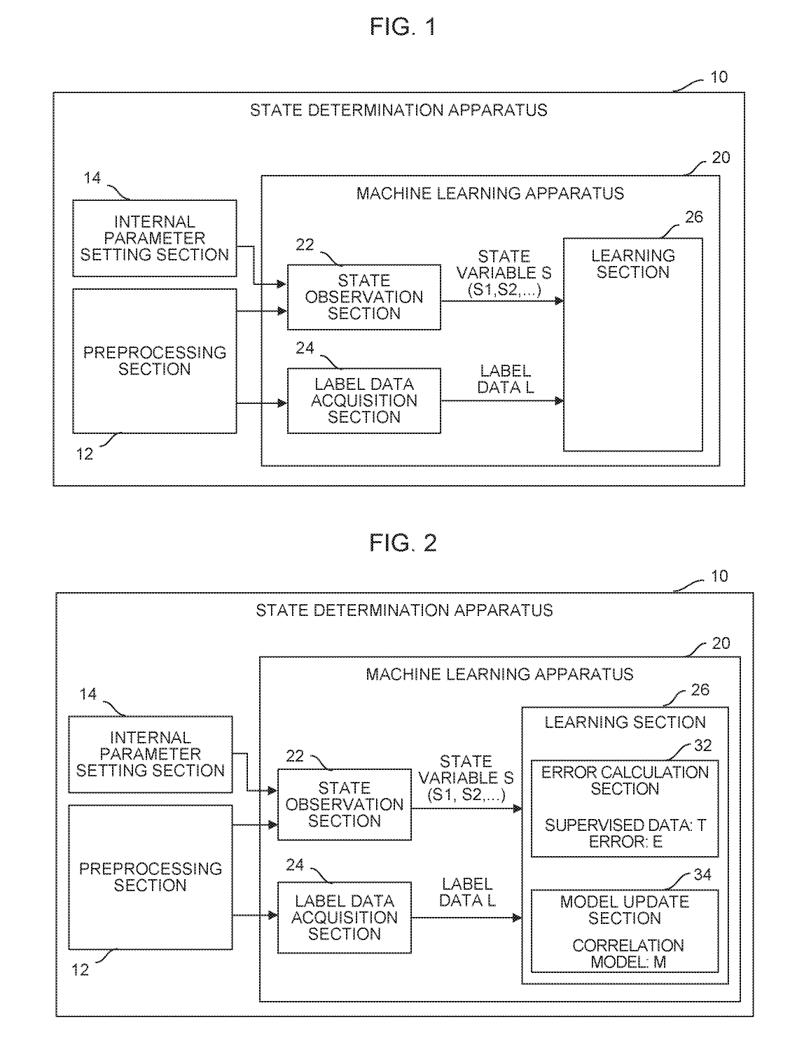

FIG. 1 is a functional block diagram showing the schematic configuration of the state determination apparatus according to a first embodiment.

A state determination apparatus 10 can be implemented as, e.g., a controller for controlling an injection molding machine, or a PC that is connected to the injection molding machine using a wired/wireless communication line so as to be capable of data communication. The state determination apparatus 10 includes a preprocessing section 12 that performs preprocessing on data acquired from the injection molding machine, an internal parameter setting section 14 in which fixed internal parameter values are set, and a machine learning apparatus 20 that includes software (a learning algorithm or the like) and hardware (a CPU of a computer or the like) for the machine learning apparatus 20 to learn a state related to an abnormality of the injection molding machine by what is called machine learning.

The state related to the abnormality of the injection molding machine learned by the machine learning apparatus 20 of the state determination apparatus 10 corresponds to a model structure that represents correlation between an operation state of the injection molding machine (injection data acquired from the injection molding machine) and the state related to the abnormality of the injection molding machine in the above operation state (presence or absence of the abnormality, a portion where the abnormality is present, and the like).

As shown by the functional blocks in FIG. 1, the machine learning apparatus 20 of the state determination apparatus 10 includes a state observation section 22 that observes, as a state variable S, the current environmental states which include injection data S1 indicative of the operation state of the injection molding machine that is acquired from the injection molding machine (not shown) and an internal parameter S2, a label data acquisition section 24 that acquires label data L indicative of the state related to the abnormality of the injection molding machine, and a learning section 26 that performs learning by associating the label data L with the injection data S1 and the internal parameter S2 using the state variable S and the label data L.

The preprocessing section 12 can be configured as, e.g., one function of the CPU of the computer. Alternatively, the preprocessing section 12 can be configured as, e.g., software for causing the CPU of the computer to function. The preprocessing section 12 performs the preprocessing on at least one of data obtained from the injection molding machine or a sensor mounted to the injection molding machine, data obtained by using or converting the above data, and data input to the injection molding machine, and outputs the data having been subjected to the preprocessing to each of the state observation section 22 and the label data acquisition section 24. The preprocessing section 12 sends data other than the data subjected to the preprocessing to the machine learning apparatus 20 without performing the preprocessing. An example of the preprocessing performed by the preprocessing section 12 includes adjustment of the number of pieces of sampling data. The adjustment of the number of pieces of the sampling data mentioned herein is processing obtained by combining reduction of the number of pieces of the data by the moving average, data thinning, or partial extraction, and increase of the number of pieces of the data by intermediate point interpolation or fixed value addition. The preprocessing performed by the preprocessing section 12 may be combined with processing related to scaling such as typical standardization.

The data acquired from the injection molding machine includes two types of data: sampling data acquired at specific sampling intervals for each molding operation and data acquired once for each molding operation. A step of a given molding operation (e.g., a mold clamping operation) has different amounts of time required from the start to the end of the step depending on an operation setting, and hence the number of pieces of the sampling data obtained in the same operation differs even when the sampling data is acquired at the same sampling intervals.

The preprocessing section 12 adjusts the number of pieces of the sampling data in the machine learning of the injection molding machine, and sends the adjusted data to each of the state observation section 22 and the label data acquisition section 24 to thereby play a role in maintaining and improving the accuracy of the machine learning by the machine learning apparatus 20 in spite of diversity of the operation setting.

The internal parameter setting section 14 can be configured as, e.g., one function of the CPU of the computer. Alternatively, the internal parameter setting section 14 can be configured as, e.g., software for causing the CPU of the computer to function. The internal parameter setting section 14 stores, among values input to the machine learning apparatus 20, a series of input fixed values as internal parameters in the form of a data table or a file, and outputs the stored internal parameters when the learning by the machine learning apparatus 20 is performed. The internal parameters mentioned herein (the series of input fixed values among values input to the machine learning apparatus 20) are a series of values that are determined based on the setting of the injection molding machine or the environment of the operation and do not change during the molding operation such as, e.g., a series of parameters determined in operations that use different resins, a series of parameters determined in operations that use different molds, or a series of parameters determined in operations having different machine specifications. The internal parameter may also be a value determined by using the machine learning in advance or at any timing.

The state observation section 22 can be configured as, e.g., one function of the CPU of the computer. Alternatively, the state observation section 22 can be configured as, e.g., software for causing the CPU of the computer to function. As the injection data S1 included in the state variable S observed by the state observation section 22, it is possible to use data that indicates the operation state of the injection molding machine, and includes the data having been subjected to the preprocessing that is obtained by performing the adjustment of the number of pieces of the data on, e.g., the data obtained from the injection molding machine or the sensor mounted to the injection molding machine, or the data obtained by using or converting the above data by the preprocessing section 12. As the injection data S1, it is possible to use, e.g., the torque (current and voltage) of a motor for driving a plasticizing screw during an injection step in the molding operation, the operation speed, position, and operating noise of the screw, and a pressure detected by a sensor mounted to a mold.

In addition, as the internal parameter S2 included in the state variable S observed by the state observation section 22, data input from the internal parameter setting section 14 is used.

The label data acquisition section 24 can be configured as, e.g., one function of the CPU of the computer. Alternatively, the label data acquisition section 24 can be configured as, e.g., software for causing the CPU of the computer to function. As the label data L acquired by the label data acquisition section 24, it is possible to use data obtained by causing the preprocessing section 12 to perform the preprocessing on report data related to the abnormality of the injection molding machine that is reported and given to the state determination apparatus 10 in the case where, e.g., a skillful worker performs determination of the injection molding machine and determines that the abnormality is present in the injection molding machine.

The label data L may be any data that allows determination of change from a reference state, and it is possible to use the wear amount of a component such as, e.g., a screw, a timing belt, or a bearing, and the wear amount and predicted life of the mold. The label data L indicates the state related to the abnormality of the injection molding machine under the state variable S.

Thus, while the machine learning apparatus 20 of the state determination apparatus 10 performs the learning, in the environment, the molding operation by the injection molding machine is executed, the measurement of the operation state of the injection molding machine by the sensor and the like is executed, and the determination of the state related to the abnormality of the injection molding machine by the skillful worker is executed.

The learning section 26 can be configured as, e.g., one function of the CPU of the computer. Alternatively, the learning section 26 can be configured as, e.g., software for causing the CPU of the computer to function. The learning section 26 learns the state related to the abnormality of the injection molding machine correlated with the operation state of the injection molding machine in accordance with any learning algorithm that is collectively called machine learning. The learning section 26 is capable of repeatedly executing learning based on a data set including the state variable S and the label data L described above on a plurality of molding operations of the injection molding machine.

By repeating the above learning cycle, the learning section 26 is capable of automatically recognizing features that suggest correlation between the data (the injection data S1) on the injection operation of the injection molding machine and the internal parameter S2, and the state related to the abnormality of the injection molding machine. When the learning algorithm is started, the correlation between the injection data S1 and the internal parameter S2, and the state related to the abnormality of the injection molding machine is substantially unknown, but the learning section 26 gradually recognizes the features as the learning progresses, and interprets the correlation. When the correlation between the injection data S1 and the internal parameter S2, and the state related to the abnormality of the injection molding machine is interpreted to a certain degree of reliability, the result of the learning repeatedly output by the learning section 26 can be used for performing selection of an action (i.e., decision making) regarding how the state related to the abnormality of the injection molding machine should be determined based on the current operation state. That is, as the learning algorithm progresses, the learning section 26 is capable of causing the correlation between the current operation state of the injection molding machine and the action regarding how the state related to the abnormality of the injection molding machine should be determined based on the current operation state to gradually approach an optimal solution.

As described above, in the machine learning apparatus 20 of the state determination apparatus 10, the learning section 26 learns the state related to the abnormality of the injection molding machine correlated with the current operation state of the injection molding machine in accordance with the machine learning algorithm by using the state variable S observed by the state observation section 22 and the label data L acquired by the label data acquisition section 24. The state variable S used in the learning includes the injection data S1 and the internal parameter S2 that are pieces of data unlikely to be affected by disturbance, and the label data L is determined uniquely based on the report data of the skillful worker. Consequently, according to the machine learning apparatus 20 of the state determination apparatus 10, by using the result of the learning of the learning section 26, it becomes possible to automatically and accurately perform the determination of the state related to the abnormality of the injection molding machine correlated with the operation state of the injection molding machine without depending on computation or estimation.

When it is possible to automatically perform the determination of the state related to the abnormality of the injection molding machine without depending on the computation or estimation, it is possible to quickly determine the state related to the abnormality of the injection molding machine only by actually measuring and acquiring the operation state of the injection molding machine during the molding operation by the injection molding machine. Consequently, it is possible to reduce time required for the determination of the state related to the abnormality of the injection molding machine. In addition, it becomes possible for the worker to determine whether or not the injection molding machine is normal based on details determined by the state determination apparatus 10, and easily perform planning of maintenance and preparation of maintenance components.

As a modification of the state determination apparatus 10, the internal parameter setting section 14 may hold a plurality of series of the internal parameters in the form of the data table or the file, and may output one of the plurality of series of the internal parameters that is selected by the worker to the machine learning apparatus 20 in accordance with the molding operation executed in the injection molding machine. The selection of the series of the internal parameters output to the machine learning apparatus 20 by the internal parameter setting section 14 may be automatically performed by the injection molding machine or the state determination apparatus 10 based on a value related to the molding operation set for the injection molding machine or a detected value.

The state determination apparatus according to the present invention includes the above configuration, whereby it becomes possible to create a machine learning model that can be versatilely used under conditions of a wide variety of the molding operations, and the effect of increasing determination accuracy by the machine learning model relatively easily is expected to be achieved. In addition, as the feature of the machine learning, the determination accuracy by the machine learning model for molding under a given condition is increased, and hence it is possible to perform relearning of the machine learning using the state variable under the above condition, determine a new internal parameter, and update the parameter with the new parameter. On the other hand, the new parameter obtained by the relearning is optimized under the condition, and hence the determination accuracy may be spoiled when the condition of the molding operation is changed. To cope with this, for example, by preparing a series of versatile parameters, a series of parameters for relearning and updating, and a series of parameters under another condition, and switching among them in response to the change of the molding operation or the mold, it becomes possible to cope with the change of the molding operation flexibly.

As a modification of the machine learning apparatus 20 of the state determination apparatus 10, the learning section 26 may learn the state related to the abnormality of the injection molding machine correlated with each of the operation states of a plurality of injection molding machines having the same configuration by using the state variable S and the label data L obtained from each of the plurality of injection molding machines. According to this configuration, it is possible to increase the number of data sets each including the state variable S and the label data L obtained during a specific time period, and hence it is possible to improve the speed and reliability of the learning of the state related to the abnormality of the injection molding machine correlated with the operation state of the injection molding machine by using the more diversified data set as an input.

In the machine learning apparatus 20 having the above configuration, the learning algorithm executed by the learning section 26 is not particularly limited, and it is possible to adopt known learning algorithms as the machine learning. FIG. 2 shows an aspect of the state determination apparatus 10 shown in FIG. 1, and shows a configuration that includes the learning section 26 that executes supervised learning as an example of the learning algorithm. The supervised learning is a method for learning a correlation model (the state related to the abnormality of the injection molding machine correlated with the operation state of the injection molding machine in the case of the machine learning apparatus 20 shown in FIGS. 1 and 2) for estimating a required output to a new input by providing a large number of known data sets (referred to as supervised data) of inputs and outputs corresponding to the inputs, and recognizing a feature that suggests correlation between the input and the output from the supervised data.

In the machine learning apparatus 20 of the state determination apparatus 10 shown in FIG. 2, the learning section 26 includes an error calculation section 32 that calculates an error E between a correlation model M that derives the state related to the abnormality of the injection molding machine from the state variable S and a correlation feature recognized from supervised data T prepared in advance, and a model update section 34 that updates the correlation model M so as to reduce the error E. The learning section 26 learns the state related to the abnormality of the injection molding machine correlated with the operation state of the injection molding machine by causing the model update section 34 to repeat the update of the correlation model M.

The correlation model M can be created by using regression analysis, reinforcement learning, and deep learning. The initial value of the correlation model M is given to the learning section 26 before the start of the supervised learning as, e.g., a value that represents the correlation between the state variable S and the state related to the abnormality of the injection molding machine in a simplified form. The supervised data T is constituted by empirical values (a known data set of the operation state of the injection molding machine and the state related to the abnormality of the injection molding machine) accumulated by recording the state related to the abnormality of the injection molding machine correlated with the operation state of the injection molding machine previously, and is given to the learning section 26 before the start of the supervised learning. The error calculation 32 recognizes the correlation feature that suggests the correlation between the state related to the abnormality of the injection molding machine and the operation state of the injection molding machine from a large amount of the supervised data T given to the learning section 26, and determines the error E between the correlation feature and the correlation model M corresponding to the state variable S in the current state. The model update section 34 updates the correlation model M so as to reduce the error E in accordance with, e.g., a predetermined update rule.

In the next learning cycle, by using the state variable S and the label data L obtained by execution of the molding operation by the injection molding machine according to the updated correlation model M, the error calculation section 32 determines the error E for the correlation model M corresponding to the state variable S and the label data L, and the model update section 34 updates the correlation model M again. In this manner, the correlation between the current state of the environment (the operation state of the injection molding machine) that has been unknown and the corresponding determination of the state (the determination of the state related to the abnormality of the injection molding machine) is gradually revealed. That is, with the update of the correlation model M, the relationship between the operation state of the injection molding machine and the state related to the abnormality of the injection molding machine is caused to approach an optimal solution.

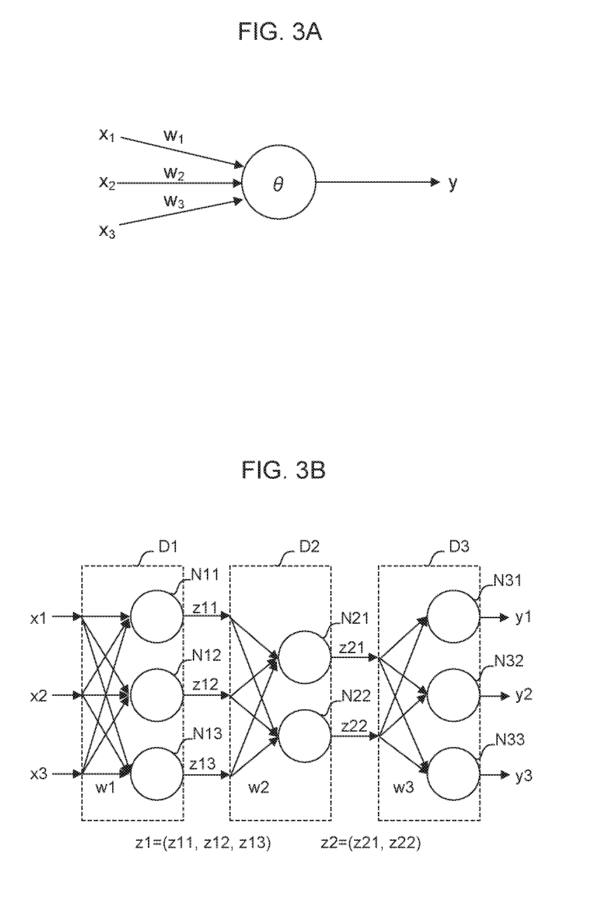

When the supervised learning described above is performed, it is possible to use, e.g., a neural network. FIG. 3A schematically shows the model of a neuron constituting the neural network. FIG. 3B schematically shows the model of a three-layer neural network configured by combining the neurons shown in FIG. 3A. The neural network can be configured by, e.g., an arithmetic unit or a storage unit that simulates the neuron model.

The neuron shown in FIG. 3A outputs a result y to a plurality of inputs x (herein, inputs x₁ to x₃ are shown as examples). The inputs x₁ to x₃ are multiplied by weights w (w₁ to w₃) corresponding to the inputs x. With this, the neuron outputs an output y represented by the following Expression (1). Note that, in Expression (1), all of the input x, the output y, and the weight w are vectors. θ is a bias, and fₖ is an activation function.

y=fₖ(Σᵢ₌₁ⁿxᵢwᵢ−θ)Λ (1)

In the three-layer neural network shown in FIG. 3B, a plurality of inputs x (herein, inputs x1, x2, and x3 are shown as examples) are input from the left side, and results y (herein, results y1, y2, and y3 are shown as examples) are output from the right side. In the example shown in the drawing, the inputs x1, x2, and x3 are multiplied by corresponding weights (collectively represented by w1), and each of the inputs x1, x2, and x3 is input to three neurons N11, N12, and N13.

In FIG. 3B, outputs of the neurons N11, N12, and N13 are collectively represented by z1. z1 can be regarded as feature vectors obtained by extracting the feature quantities of input vectors. In the example shown in the drawing, the feature vectors z1 are multiplied by corresponding weights (collectively represented by w2), and each of the feature vectors z1 is input to two neurons N21 and N22. The feature vectors z1 represent features between the weights w1 and the weights w2.

In FIG. 3B, outputs of the neurons N21 and N22 are collectively represented by z2. z2 can be regarded as feature vectors obtained by extracting the feature quantities of the feature vectors z1. In the example shown in the drawing, the feature vectors z2 are multiplied by corresponding weights (collectively represented by w3), and each of the feature vectors z2 is input to three neurons N31, N32, and N33. The feature vectors z2 represent features between the weights w2 and the weights w3. Lastly, the neurons N31, N32, and N33 output results y1, y2, and y3, respectively.

In the machine learning apparatus 20 of the state determination apparatus 10, the learning section 26 is capable of outputting the state related to the abnormality of the injection molding machine (the result y) by performing a computation with a multi-layer structure according to the neural network described above by using the state variable S as the input x. Note that an operation mode of the neural network includes a learning mode and a determination mode and, for example, it is possible to learn a weight W by using a learning data set in the learning mode, and perform the determination of the state related to the abnormality of the injection molding machine in the determination mode by using the learned weight W. Note that it is also possible to perform detection, classification, and inference in the determination mode.

The configuration of the state determination apparatus 10 described above can be described as a machine learning method (or software) executed by the CPU of the computer. The machine learning method is the method for learning the state related to the abnormality of the injection molding machine correlated with the operation state of the injection molding machine, and includes the steps of:

causing the CPU of the computer to observe each of the internal parameter S2 and the injection data S1 that indicates the operation state of the injection molding machine as the state variable S that represents the current state of the environment in which the molding operation by the injection molding machine is performed;

acquiring the label data L that indicates the state related to the abnormality of the injection molding machine; and

performing learning by associating the operation state of the injection molding machine with the state related to the abnormality of the injection molding machine using the state variable S and the label data L.

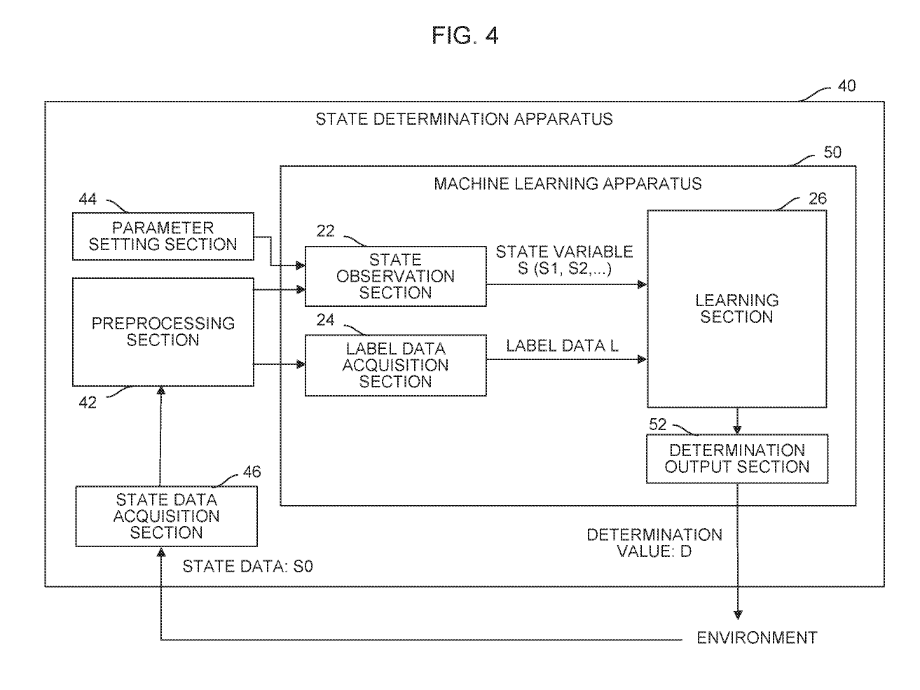

FIG. 4 shows a state determination apparatus 40 according to a second embodiment.

The state determination apparatus 40 includes a preprocessing section 42, a parameter setting section 44, a machine learning apparatus 50, and a state data acquisition section 46 that acquires data input to the preprocessing section 42 as state data S0. The state data acquisition section 46 is capable of acquiring the state data S0 from the injection molding machine or the sensor mounted to the injection molding machine, or by data inputting performed appropriately by the worker.

In addition to the software (the learning algorithm or the like) and the hardware (the CPU of the computer or the like) for the machine learning apparatus 50 to learn the state related to the abnormality of the injection molding machine correlated with the operation state of the injection molding machine by the machine learning, the machine learning apparatus 50 of the state determination apparatus 40 includes software (a computational algorithm or the like) and hardware (the CPU of the computer or the like) for outputting the state related to the abnormality of the injection molding machine determined based on the operation state of the injection molding machine by the learning section 26 as display of characters in a display apparatus (not shown), sound or voice output to a speaker (not shown), output by an alarm lamp (not shown), or a combination thereof. The machine learning apparatus 50 of the state determination apparatus 40 can be configured such that one common CPU executes all software such as the learning algorithm and the computational algorithm.

A determination output section 52 can be configured as, e.g., one function of the CPU of the computer. Alternatively, the determination output section 52 can be configured as, e.g., software for causing the CPU of the computer to function. The determination output section 52 outputs an instruction so as to notify the worker of the state related to the abnormality of the injection molding machine determined based on the operation state of the injection molding machine by the learning section 26 as the display of characters, the sound or voice output, the output by the alarm lamp, or the combination thereof. The determination output section 52 may output the instruction for the notification to the display apparatus of the state determination apparatus 40, and may also output the instruction for the notification to the display apparatus of the injection molding machine.

The machine learning apparatus 50 of the state determination apparatus 40 having the above configuration achieves the same effect as that of the machine learning apparatus 20 described above. In particular, the machine learning apparatus 50 is capable of changing the state of the environment by using the output of the determination output section 52. On the other hand, the machine learning apparatus 20 can cause an external apparatus (e.g., the controller of the injection molding machine) to perform a function corresponding to the determination output section for reflecting the learning result of the learning section 26 in the environment.

As a modification of the state determination apparatus 40, the determination output section 52 may allocate a predetermined specific threshold value to each state related to the abnormality of the injection molding machine determined based on the operation state of the injection molding machine by the learning section 26, and may output information serving as a warning in the case where the state related to the abnormality of the injection molding machine determined based on the operation state of the injection molding machine by the learning section 26 exceeds the threshold value.

As another modification of the state determination apparatus 40, the determination output section 52 may calculate a difference between each state related to the abnormality of the injection molding machine determined based on the operation state of the injection molding machine previously by the learning section 26 and each state related to the abnormality of the injection molding machine determined based on the operation state of the injection molding machine currently by the learning section 26, and may output the information serving as the warning in the case where the calculated difference exceeds a predetermined threshold value. The state related to the abnormality of the injection molding machine determined based on the operation state of the injection molding machine previously by the learning section 26 may be the state determined by the learning section 26 at any previous timing. However, the inference of the state based on comparison is facilitated by using the state related to the abnormality of the injection molding machine when the state can be grasped clearly such as, e.g., when a component is replaced with a new component.

As another modification of the state determination apparatus 40, in order to acquire the state variable when the determination of the state related to the abnormality of the injection molding machine by the learning section 26 and the determination output section 52 is performed, the state determination apparatus 40 may instruct the injection molding machine to perform a specific molding operation based on a preset specific operation setting.

In the molding operation by the injection molding machine, it is necessary to perform various types of settings for the individual portions of the injection molding machine such as settings of, e.g., the shape of the plasticizing screw, materials, and the shape of the mold. To cope with this, by causing the injection molding machine to perform the “specific operation” based on the predetermined operation setting having few disturbance elements when the determination of the state related to the abnormality of the injection molding machine by the learning section 26 and the determination output section 52 is performed, it becomes possible to determine states related to wear, damage, a malfunction, and maintenance with high accuracy. Examples of the “specific operation” mentioned herein include, as an operation associated with the mold, causing a mold clamping portion or an ejection portion to operate after determining settings of the position, speed, and number of times of the operation of the mold clamping portion or the ejection portion, and, as an operation associated with a heating cylinder, causing the plasticizing screw to operate after determining settings of the operation speed, position, pressure, and number of times of the operation of the plasticizing screw. Since the specific operation used in the determination is predetermined, the machine learning model can be configured by using a simple configuration, and the effect of being able to configure the state determination apparatus by using an inexpensive system is expected to be achieved by simplifying processing required for the determination.

In addition, the state determination apparatus 40 may instruct the injection molding machine to automatically perform the above-described specific operation at power-on or before and after a predetermined operation such as a resin discharging operation, may instruct the injection molding machine to automatically perform the specific operation in the case where a specific time period has elapsed, may instruct the injection molding machine to automatically perform the specific operation when the worker makes a request using a button provided in the state determination apparatus 40 or the injection molding machine, or may instruct the injection molding machine to automatically perform the specific operation by using conditions obtained by combining the above conditions as a reference.

Further, the state determination apparatus 40 may store a time at which the determination processing by the learning section 26 and the determination output section 52 has been executed after instructing the injection molding machine to perform the specific operation, and the determination output section 52 may output, as a warning, information indicating that a specific time period has elapsed since the previous determination in the case where a difference between the current time and the stored processing time exceeds predetermined time. With this, it becomes possible to prevent the worker from forgetting to execute the processing of the state determination and continuously operating the machine.

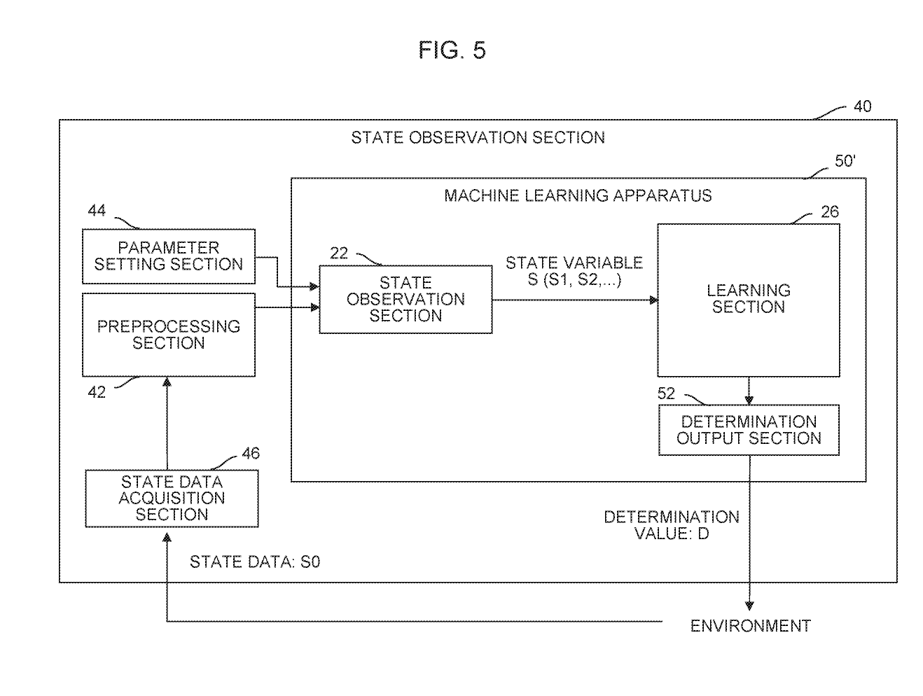

As another modification of the state determination apparatus 40, the state determination apparatus 40 can be configured to perform only the determination of the state of the injection molding machine (operate only in the determination mode) by using the result of the learning by the machine learning apparatus 50 without performing additional learning. As shown in FIG. 5, a machine learning apparatus 50′ is incorporated in the state determination apparatus 40. The machine learning apparatus 50′ is configured as an apparatus obtained by removing the label data acquisition section 24 from the machine learning apparatus 50 explained in FIG. 4.

With this configuration, the machine learning apparatus 50′ determines the state of the injection molding machine based on the state variable S observed by the state observation section 22, and the determination output section 52 outputs the determination result. Since the learning section 26 does not perform additional learning, the machine learning device 50′ can be configured by using a CPU having relatively low computational capability, and an advantage in terms of cost is obtained. In particular, in the case where the state determination apparatus 40 is introduced to the market as a product, it is possible to hold down the price by adopting the configuration of the present modification.

As another modification of the state determination apparatus 40, the state determination apparatus 40 may be operated after several patterns of parameters of the correlation model M (e.g., in the case where the correlation model M is the neural network, such parameter may be the weight value between neurons or the like) obtained as the result of the machine learning under a plurality of conditions by the learning section 26 are stored, and the pattern of parameters is set in the correlation model M in accordance with a situation in which the state determination apparatus 40 is used. At this point, the pattern of parameters of the correlation model M can be stored in, e.g., the parameter setting section 44. With this configuration, even in the case where the condition under which the state determination apparatus 40 performs the determination of the state of the injection molding machine differs, by setting the parameters of the correlation model M suitable for the condition in the learning section 26, it becomes possible to perform the determination of the state of the injection molding machine having higher accuracy.

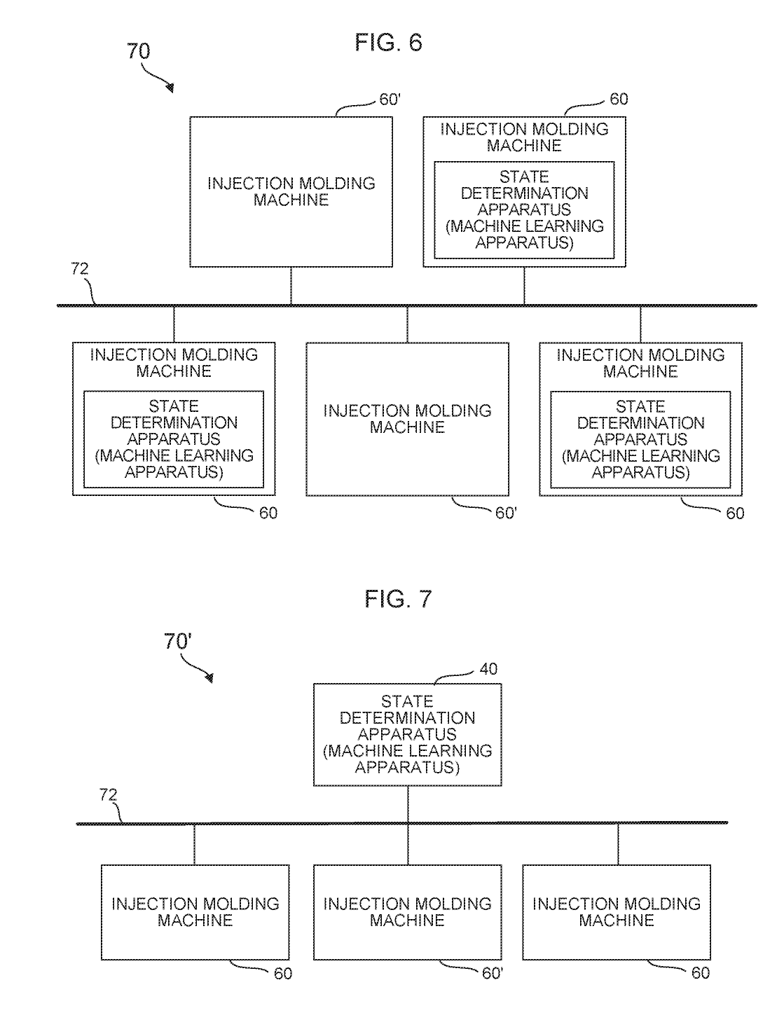

FIG. 6 shows an injection molding system 70 according to an embodiment that includes an injection molding machine 60.

The injection molding system 70 includes a plurality of injection molding machines 60 and 60′ having the same mechanical structure, and a network 72 that connects the injection molding machines 60 and 60′ to each other. Note that at least one of the plurality of injection molding machines 60 and 60′ includes the above-described state determination apparatus 40. In addition, the injection molding system 70 can include the injection molding machine 60′ that does not have the state determination apparatus 40. Each of the injection molding machines 60 and 60′ has a typical configuration that is required to perform the molding operation.

In the injection molding system 70 having the above configuration, among the plurality of injection molding machines 60 and 60′, the injection molding machine 60 that includes the state determination apparatus 40 is capable of automatically and accurately determining the state related to the abnormality of the injection molding machine correlated with the operation state of the injection molding machine by using the result of the learning by the learning section 26 without depending on the computation or estimation. In addition, the state determination apparatus 40 of at least one injection molding machine 60 can be configured such that the state determination apparatus 40 learns the state related to the abnormality of the injection molding machine correlated with the operation state of the injection molding machine common to all of the injection molding machines 60 and 60′ based on the state variable S and the label data L obtained from each of the other plurality of injection molding machines 60 and 60′, and the learning result is shared by all of the injection molding machines 60 and 60′. Consequently, according to the injection molding system 70, it is possible to improve the speed and reliability of the learning of the state related to the abnormality of the injection molding machine correlated with the operation state of the injection molding machine by using a more diversified data set (including the state variable S and the label data L) as the input.

FIG. 7 shows an injection molding system 70′ according to another embodiment that includes the injection molding machine 60′.

The injection molding system 70′ includes a plurality of injection molding machines 60′ having the same mechanical structure, and the network 72 that connects the injection molding machines 60′ and the state determination apparatus 40 (or 10).

In the injection molding system 70′ having the above configuration, the state determination apparatus 40 (or 10) is capable of learning the state related to the abnormality of the injection molding machine correlated with the operation state of the injection molding machine common to all of the injection molding machines 60′ based on the state variable S and the label data L obtained from each of the plurality of injection molding machines 60′, and automatically and accurately determining the state related to the abnormality of the injection molding machine correlated with the operation state of the injection molding machine by using the learning result without depending on the computation or estimation.

The injection molding system 70′ can be configured such that the state determination apparatus 40 (or 10) is present in a cloud server provided in the network 72. According to this configuration, it is possible to connect the required number of the injection molding machines 60′ to the state determination apparatus 40 (or 10) when necessary irrespective of the location where each of the plurality of injection molding machines 60′ is present or timing.

The worker engaged in the operation of the injection molding system 70 or 70′ can execute the determination of whether or not the attainment level of the learning of the state related to the abnormality of the injection molding machine correlated with the operation state of the injection molding machine by the state determination apparatus 40 (or 10) has reached a required level at an appropriate timing after the start of the learning by the state determination apparatus 40 (or 10).

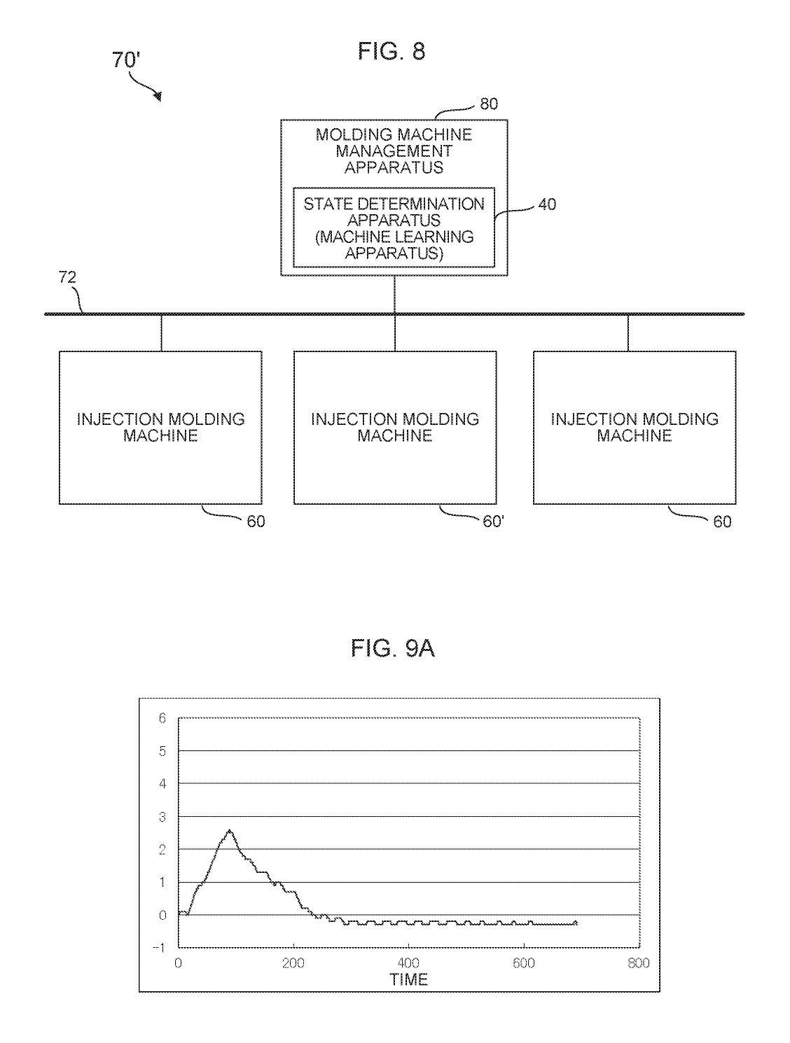

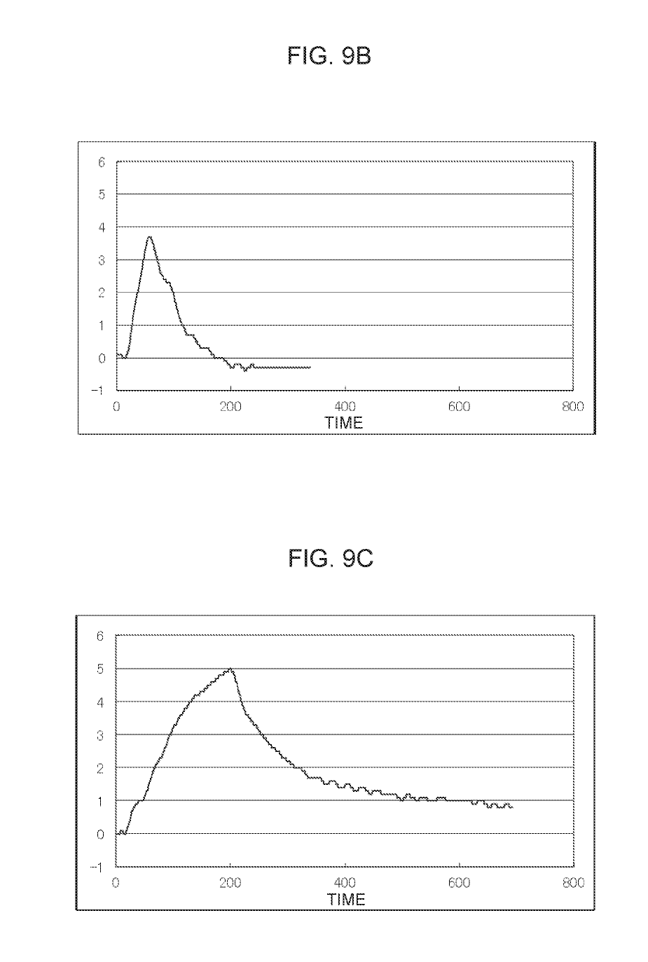

As a modification of the injection molding system 70 or 70′, it is possible to implement the state determination apparatus 40 incorporated in a molding machine management apparatus 80 that manages the injection molding machines 60 and 60′. As shown in FIG. 8, a plurality of injection molding machines 60 and 60′ are connected to the molding machine management apparatus 80 via the network 72, and the molding machine management apparatus 80 collects data on operation conditions and molding of each of the injection molding machines 60 and 60′ via the network 72.

The molding machine management apparatus 80 is capable of receiving information from any injection molding machine 60 or 60′, instructing the state determination apparatus 40 to determine the state related to the abnormality of the injection molding machine 60 or 60′, and outputting the result to the display apparatus of the molding machine management apparatus 80 or the injection molding machine 60 or 60′ serving as the determination target.

With this configuration, it is possible to unify the management of the result of the determination of the state related to the abnormality of each of the injection molding machines 60 and 60′ using the molding machine management apparatus 80, and it is possible to collect the state variables serving as samples from a plurality of injection molding machines 60 and 60′ when relearning is performed. Consequently, an advantage that many pieces of data for relearning are easily collected is obtained. Further, by associating the mold or the molding condition with the internal parameter, an advantage that determination elements related to the mold and the molding condition can be shared by the injection molding machines is obtained.

While the embodiments of the present invention have been described, the present invention is not limited to the above-described embodiments, and can be implemented in various forms by making appropriate changes thereto.

For example, the learning algorithm executed by the machine learning apparatus 20 or 50, the computational algorithm executed by the machine learning apparatus 50, and a control algorithm executed by the state determination apparatus 10 or 40 are not limited to the above-described algorithms, and it is possible to adopt various algorithms.

In addition, the preprocessing section 12 is provided in the state determination apparatus 40 (or the state determination apparatus 10) in each of the above-described embodiments, but the preprocessing section 12 may also be provided in the injection molding machine. In this case, the preprocessing may be executed in the state determination apparatus 40 (or the state determination apparatus 10) or the injection molding machine, or in both of the state determination apparatus and the injection molding machine, and the place of the preprocessing may be appropriately set in view of processing capability and communication speed.

1. A state determination apparatus for determining a state related to an abnormality of an injection molding machine based on an operation state of the injection molding machine, the state determination apparatus comprising:
a preprocessing section for executing preprocessing on at least one piece of time-series data included in data related to the operation state of the injection molding machine; and
a machine learning apparatus for learning the state related to the abnormality of the injection molding machine correlated with the operation state of the injection molding machine,
the machine learning apparatus including
a state observation section for observing, as a state variable that represents a current state of an environment, injection data that indicates the operation state of the injection molding machine and includes the piece of time-series data that has been subjected to the preprocessing by the preprocessing section,
a label data acquisition section for acquiring label data that indicates the state related to the abnormality of the injection molding machine, and
a learning section for performing learning by associating the state variable with the label data.

2. The state determination apparatus according to claim 1, further comprising:
an internal parameter setting section in which a fixed internal parameter related to the operation state of the injection molding machine is set, wherein
the state observation section is configured to observe, as the state variable that represents the current state of the environment, each of the internal parameter and the injection data that indicates the operation state of the injection molding machine and includes the piece of time-series data that has been subjected to the preprocessing by the preprocessing section.

3. The state determination apparatus according to claim 2, wherein
a plurality of internal parameters are set in the internal parameter setting section, and one of the plurality of internal parameters is selectable as the internal parameter observed as the state variable.

4. The state determination apparatus according to claim 1, wherein
the learning section includes
an error calculation section for calculating an error between a correlation model for determining the state related to the abnormality of the injection molding machine from the state variable and a correlation feature that is recognized from supervised data prepared in advance, and
a model update section for updating the correlation model so as to reduce the error.

5. The state determination apparatus according to claim 1, wherein
the learning section is configured to compute the state variable and the label data with a multi-layer structure.

6. The state determination apparatus according to claim 1, further comprising:
a determination output section for outputting the state related to the abnormality of the injection molding machine determined based on the state variable and a result of the learning by the learning section.

7. The state determination apparatus according to claim 6, wherein
the determination output section is configured to output a warning in a case where the state related to the abnormality of the injection molding machine determined by the learning section exceeds a preset threshold value.

8. The state determination apparatus according to claim 1, wherein
the preprocessing is processing in which interpolation, extraction, or a combination of the interpolation and the extraction is performed on at least one piece of time-series data included in the data related to the operation state of the injection molding machine, and the number of input pieces of the time-series data is adjusted.

9. The state determination apparatus according to claim 1, wherein
the data related to the operation state of the injection molding machine is a value obtained by using at least one of a load of a drive portion or a movable portion of the injection molding machine, a speed of the drive portion or the movable portion, a position of the drive portion or the movable portion, an instruction value to the drive portion, a pressure, a mold clamping force, a temperature, a physical quantity of each molding cycle, a molding condition, a molding material, a molded article, a shape of a component of the injection molding machine, a distortion of the component of the injection molding machine, operating noise, and an image.

10. The state determination apparatus according to claim 6, wherein
the injection molding machine is caused to perform a predetermined specific operation for performing the determination of the state related to the abnormality of the injection molding machine by the learning section.

11. The state determination apparatus according to claim 10, wherein
the predetermined specific operation for performing the determination is performed automatically or at the request of a worker.

12. The state determination apparatus according to claim 10, wherein
a date and time when the predetermined specific operation for performing the determination has been performed is stored, and information is output in a case where a specific time period elapses from the stored date and time.

13. The state determination apparatus according to claim 1, wherein
the state determination apparatus is configured as part of a controller of the injection molding machine.

14. The state determination apparatus according to claim 1, wherein
the state determination apparatus is configured as part of a molding machine management apparatus for managing a plurality of injection molding machines via a network.

15. A state determination apparatus for determining a state related to an abnormality of an injection molding machine based on an operation state of the injection molding machine, the state determination apparatus comprising:
a preprocessing section for executing preprocessing on at least one piece of time-series data included in data related to the operation state of the injection molding machine; and
a machine learning apparatus having a learning section that has learned the state related to the abnormality of the injection molding machine correlated with the operation state of the injection molding machine,
the machine learning apparatus including
a state observation section for observing, as a state variable that represents a current state of an environment, injection data that indicates the operation state of the injection molding machine and includes the piece of time-series data that has been subjected to the preprocessing by the preprocessing section, and
a determination output section for outputting the state related to the abnormality of the injection molding machine determined based on the state variable and a result of the learning by the learning section.
